(19) United States
(12) Patent Application Publication
(10) Pub. No.: US 2025/0232677 A1
(43) Pub. Date: Jul. 17, 2025

(54) OPERATION MANAGEMENT DEVICE AND MaaS PROVIDING METHOD

(71) Applicant: TOYOTA JIDOSHA KABUSHIKI KAISHA, Toyota-shi (JP)

(72) Inventor: Katsuhiro WATANABE, Kawasaki-shi (JP)

(73) Assignee: TOYOTA JIDOSHA KABUSHIKI KAISHA, Toyota-shi (JP)

(21) Appl. No.: 19/004,724

(22) Filed: Dec. 30, 2024

(30) Foreign Application Priority Data
Jan. 17, 2024 (JP) 2024-005504

(51) Int. Cl. G08G 1/00; B60W 50/14; B60W 60/00

(52) U.S. Cl. CPC G08G 1/22; B60W 50/14; B60W 60/001

(57) ABSTRACT

An operation management device comprising a control unit configured to: acquire plan data indicating an operation plan for operating autonomous vehicles on a plurality of routes at regular intervals; acquire record data indicating an operation record including times at which the autonomous vehicles on individual routes arrived at stops set on the individual routes; and when an autonomous vehicle in which delay of the time of arrival at any one of the stops in the operation record indicated by the acquired record data from a time associated with the operation plan indicated by the acquired plan data exceeds a threshold is detected as a delay vehicle among the autonomous vehicles on the routes, select, as an influence vehicle, an autonomous vehicle on one or more routes to be adjusted in terms of an operation interval from among the autonomous vehicles on the routes.

### CROSS-REFERENCE TO RELATED APPLICATION

This application claims priority to Japanese Patent Application No. 2024-005504 filed on Jan. 17, 2024, incorporated herein by reference in its entirety.

### BACKGROUND

### 1. Technical Field

The present disclosure relates to an operation management device and a MaaS providing method.

### 2. Description of Related Art

Japanese Unexamined Patent Application Publication No. 2023-132714 (JP 2023-132714 A) discloses an operation management system that predicts occurrence of incidents on a road during operation of an autonomous vehicle, and updates a recommended speed set for the road in accordance with results of the prediction.

### SUMMARY

In the related-art operation management system, the measure against the delay of the autonomous vehicle is insufficient.

It is an object of the present disclosure to improve the measure against a delay of an autonomous vehicle.

An operation management device according to the present disclosure includes a control unit configured to:
acquire plan data indicating an operation plan for operating autonomous vehicles on a plurality of routes at regular intervals;
acquire record data indicating an operation record including times at which the autonomous vehicles on individual routes arrived at stops set on the individual routes;
when an autonomous vehicle in which delay of the time of arrival at any one of the stops in the operation record indicated by the acquired record data from a time associated with the operation plan indicated by the acquired plan data exceeds a threshold is detected as a delay vehicle among the autonomous vehicles on the routes, select, as an influence vehicle, an autonomous vehicle on one or more routes to be adjusted in terms of an operation interval from among the autonomous vehicles on the routes;
calculate a waiting period at a next stop for instruction to the selected influence vehicle based on the operation record indicated by the record data; and
output time data indicating the calculated waiting period.

According to the present disclosure, it is possible to improve the measure against the delay of the autonomous vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to an embodiment of the present disclosure;

FIG. 2 is a block diagram illustrating a configuration of an operation management device according to an embodiment of the present disclosure;

FIG. 3 is a diagram illustrating an example of operation of one route according to an embodiment of the present disclosure;

FIG. 4 is a diagram illustrating an example of operation of one route according to an embodiment of the present disclosure when the first method is employed;

FIG. 5 is a diagram illustrating an exemplary operation of one line according to an embodiment of the present disclosure when the first method is employed; and

FIG. 6 is a flowchart illustrating an operation of the operation management device according to the embodiment of the present disclosure.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of each embodiment, description of the same or corresponding components will be appropriately omitted or simplified.

An embodiment of the present disclosure will be described.

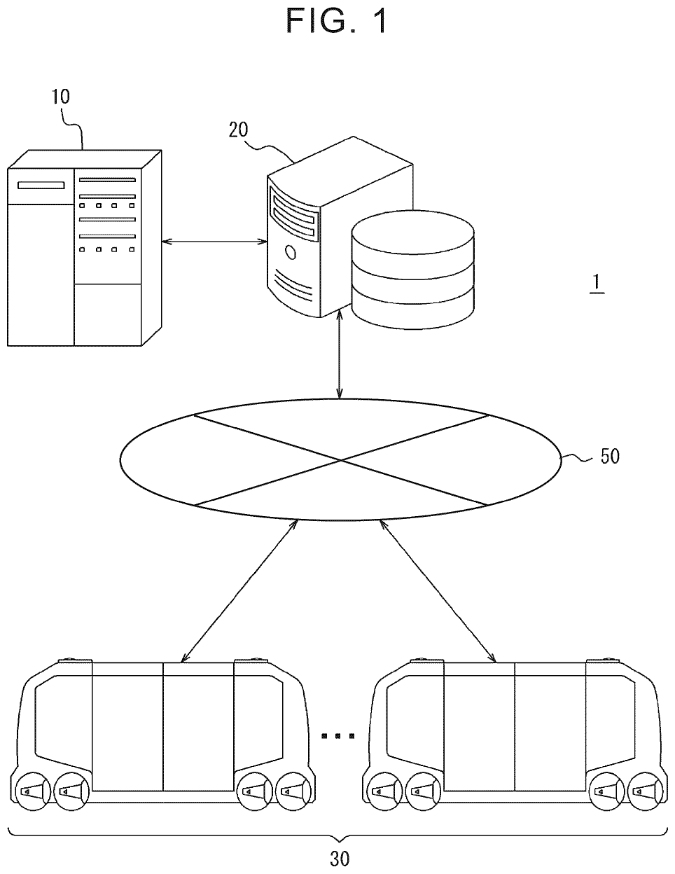

A configuration of the system 1 according to the present embodiment will be described with reference to FIG. 1.

The system 1 according to the present embodiment includes an operation management device 10, an autonomous driving control device 20, and autonomous vehicles 30 on a plurality of routes. The operation management device 10 is communicably connected to the autonomous driving control device 20. The autonomous driving control device 20 is capable of communicating with the autonomous vehicles 30 on a plurality of routes via the network 50. The operation management device 10 may be capable of communicating with the autonomous driving control device 20 via the network 50.

The operation management device 10 is installed in a facility such as a data center. The operation management device 10 is a computer such as a server belonging to a cloud computing system or other computing system.

The autonomous driving control device 20 is installed in a facility such as a data center. The autonomous driving control device 20 is a computer such as a server belonging to a cloud computing system or another computing system.

The autonomous vehicles 30 on a plurality of routes are any type of vehicle, such as a gasoline vehicle, diesel vehicle, hydrogen vehicle, HEV, PHEV, BEV, or FCEV, for example. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle. The autonomous vehicles 30 on a plurality of routes are AV in the present embodiment, and the driving is automated at a high level. AV stands for autonomous vehicle. The level of automation is, for example, either level 3 or level 4 in the level division of SAE. “SAE” is an abbreviation for Society of Automotive Engineers. The autonomous vehicles 30 on a plurality of routes may be MaaS dedicated vehicles. MaaS is an abbreviation for Mobility as a Service.

The network 50 includes the Internet, at least one WAN, at least one MAN, or any combination thereof. WAN is an abbreviation for wide area network. MAN is an abbreviation for metropolitan area network. The network 50 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

The operation management device 10 acquires plan data indicating an operation plan for operating the autonomous vehicles 30 on a plurality of routes at regular intervals. The operation management device 10 acquires actual data indicating an operation result including a time at which the autonomous vehicle of each route arrives at each stop determined for each route. The operation management device 10 detects, as the delayed vehicle DeV, an autonomous vehicle whose delay from the time corresponding to the operation plan indicated by the acquired plan data at the time when the vehicle arrived at any one of the stopping places included in the operation result indicated by the acquired result data among the autonomous vehicles 30 on a plurality of routes. Then, the operation management device 10 selects, as the influenced vehicle AfV, an autonomous vehicle on one or more routes for adjusting the operation interval from among the autonomous vehicles 30 on a plurality of routes. The operation management device 10 calculates a waiting time at the next stop, which is instructed to the selected AfV of affected vehicles, based on the operation results indicated by the result data. The operation management device 10 outputs time data indicating the calculated standby time.

According to the present embodiment, it is possible to adjust the operation interval of the autonomous vehicle in accordance with the delay state. Therefore, it is possible to improve measures against the delay of the autonomous vehicle.

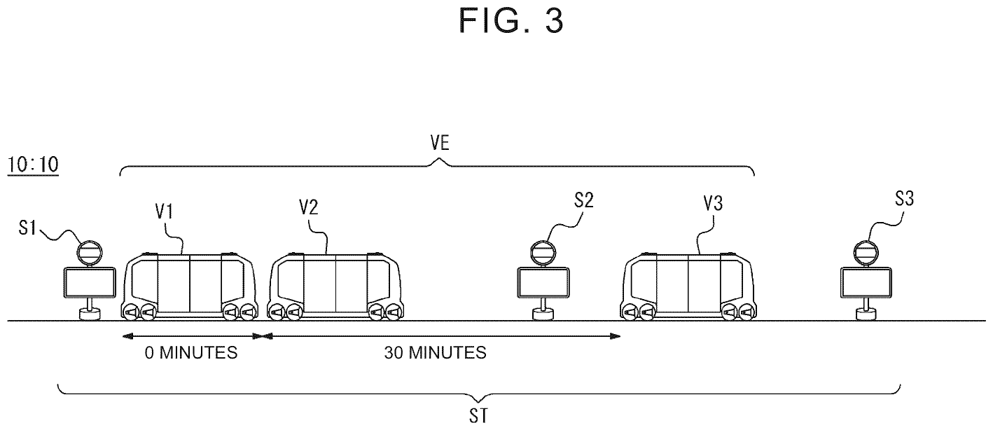

In the embodiment of FIG. 3, the autonomous vehicle VE belonging to one route among the autonomous vehicles 30 on a plurality of routes stops at the stop ST of the route. The autonomous vehicle VE includes a first autonomous vehicle V1, a second autonomous vehicle V2, and a third autonomous vehicle V3. The number of autonomous vehicles is three in the example of FIG. 3, but may be two or four or more. The stop ST includes a first stop S1, a second stop S2, and a third stop S3. The number of stops is three in the example of FIG. 3, but may be two or four or more. The number of stops may be greater or less than the number of autonomous vehicles. The operation of the autonomous vehicle VE is planned so that the operation intervals of the respective autonomous vehicles are 20 minutes. In the embodiment of FIG. 3, in the first stop S1, the operation is planned such that the first autonomous vehicle V1 arrives at 10:00, the second autonomous vehicle V2 arrives at 10:20, and the third autonomous vehicle V3 arrives at 10:40. In the second stop S2, the operation is planned so that the first autonomous vehicle V1 arrives at 9:40, the second autonomous vehicle V2 arrives at 10:00, and the third autonomous vehicle V3 arrives at 10:20. That is, the first autonomous vehicle V1 is the preceding vehicle, the second autonomous vehicle V2 is the following vehicle, and the third autonomous vehicle V3 is the following vehicle. During operation, the arrival time may be around depending on the climate, road or passenger circumstances. When the autonomous vehicle VE arrives at the stop ST, it transmits time data indicating the actual arrival time to the autonomous driving control device 20.

In one embodiment, the operation management device 10 may be used to provide a MaaS that is a service that utilizes mobility.

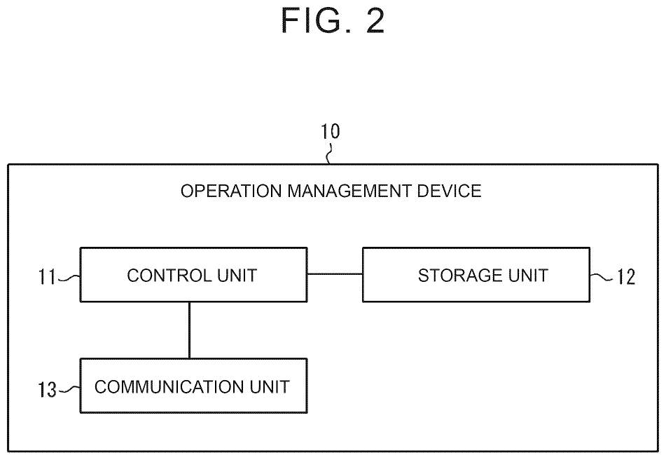

A configuration of the operation management device 10 according to the present embodiment will be described with reference to FIG. 2.

The operation management device 10 includes a control unit 11, a storage unit 12, and a communication unit 13.

The control unit 11 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 11 executes processing related to the operation of the operation management device 10 while controlling each unit of the operation management device 10.

The storage unit 12 includes at least one semiconductor memory, at least one magnetic memory, at least one optical memory, or any combination thereof. The semiconductor memory is, for example, a RAM or a ROM. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read-only memory”. The storage unit 12 may function as, for example, a main storage device, an auxiliary storage device, or a cache memory. The storage unit 12 stores data used for the operation of the operation management device 10 and data obtained by the operation of the operation management device 10.

The communication unit 13 includes at least one communication interface. The communication interface is, for example, a LAN interface. The communication unit 13 receives data used for the operation of the operation management device 10 and transmits data obtained by the operation of the operation management device 10.

The function of the operation management device 10 is realized by executing the operation management program according to the present embodiment by a processor serving as the control unit 11. That is, the functions of the operation management device 10 are realized by software. The operation management program causes the computer to function as the operation management device 10 by causing the computer to execute the operation of the operation management device 10. That is, the computer functions as the operation management device 10 by executing the operation of the operation management device 10 in accordance with the operation management program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read-only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

Some or all of the functions of the operation management device 10 may be realized by a programmable circuit or a dedicated circuit as the control unit 11. That is, some or all of the functions of the operation management device 10 may be realized by hardware.

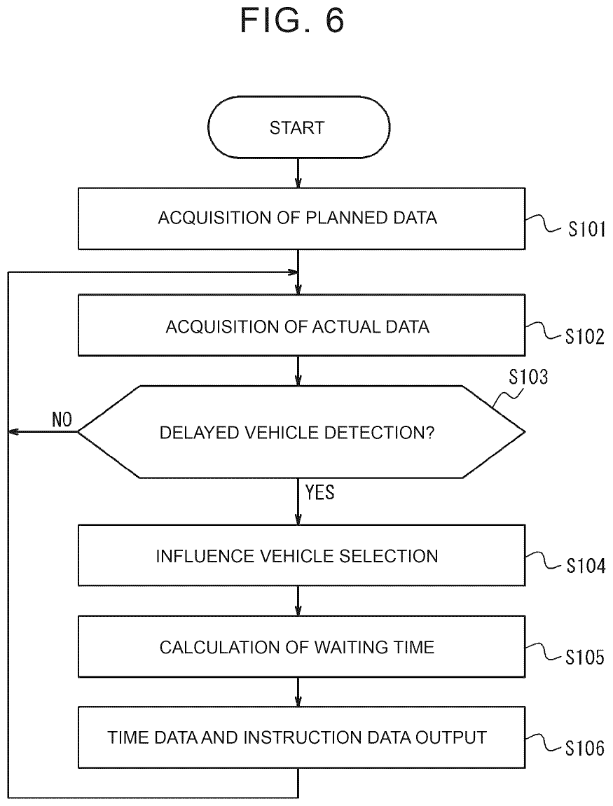

The operation of the operation management device 10 according to the present embodiment will be described with reference to FIG. 6. This operation corresponds to the operation management method according to the present embodiment.

In S101 of FIG. 6, the control unit 11 of the operation management device 10 acquires the planning data. The planning data indicates an operation plan for operating the autonomous vehicles 30 on a plurality of routes including the autonomous vehicle VE at regular intervals. For example, the plan data is registered by the operation management business operator. In the embodiment of FIG. 3, the operation plan includes a time at which the autonomous vehicle VE arrives at the stop ST. S101 is performed only once before the start of the operation of the autonomous vehicle VE, but may be performed once daily before the start of the operation of the autonomous vehicle VE.

In S102 of FIG. 6, the control unit 11 of the operation management device 10 acquires actual results. The time of arrival of the autonomous vehicle on each route such as the autonomous vehicle VE at each stop determined for each route such as the stop ST is included. Specifically, the communication unit 13 of the operation management device 10 receives, from the autonomous driving control device 20, actual data received by the autonomous driving control device 20 from the autonomous vehicle 30 on a plurality of routes. The control unit 11 acquires the actual data received by the communication unit 13. In the exemplary embodiment of FIG. 3, the operation record includes a time at which the autonomous vehicle VE arrived at the stop ST. S102 and subsequent processes are performed once every 10 minutes, but may be performed once a minute or at any other interval.

In S103 of FIG. 6, the control unit 11 of the operation management device detects, as the delayed vehicle DeV, an autonomous vehicle whose delay from the time corresponding to the operation plan indicated by the planned data acquired by S101 at the time when the vehicle arrived at any one of the stopping places included in the operation result indicated by the actual result data acquired by S102 in the autonomous vehicle VE exceeds the threshold value. The threshold value is, for example, 5 minutes. Specifically, the control unit 11 calculates a delay by subtracting the time corresponding to the operation plan from the time at which the respective vehicles in the autonomous vehicle VE arrive at any of the stop points. The control unit 11 detects, as the delayed vehicle DeV, an autonomous vehicle whose calculated delay exceeds a threshold. In the embodiment of FIG. 3, the first autonomous vehicle V1 should have arrived at the first stop S1 at 10:00 in the operation planning. In the operation record, the time when the first autonomous vehicle V1 arrives at the first stop S1 is 10:10, which is delayed by 10 minutes from the operation plan. The second autonomous vehicle V2 arrives at the second stop S2 at 9:50 and is in a position immediately before arriving at the first stop S1 at 10:10. The third autonomous vehicle V3 arrives at the third stop S3 at 10:00 and is heading toward the second stop S2 at 10:10. At 10:10, the control unit 11 calculates the delay of the first autonomous vehicle V1 as +10 minutes. The control unit 11 calculates the delay of the second autonomous vehicle V2 as −10 minutes. The control unit 11 calculates the delay of the third autonomous vehicle V3 as 0 minutes. The control unit 11 detects, as the delayed vehicle DeV, the first autonomous vehicle V1 whose delay exceeds 5 minutes. The control unit 11 repeats the process of S102 and S103 until the delayed-vehicle DeV is detected.

In S104 of FIG. 6, the control unit 11 of the operation management device 10 selects, as the affected vehicle AfV, the autonomous vehicle for adjusting the operation interval from among the autonomous vehicle VE. Any method can be employed as a method of selecting the influenced-vehicle AfV. In the example of FIG. 3, the second autonomous vehicle V2 and the third autonomous vehicle V3 are candidates for the affected vehicle AfV.

As a first way, the control unit 11 selects all other autonomous vehicles of the route to which the delayed vehicle DeV belongs as the affected vehicle AfV. In the embodiment of FIG. 3, the control unit 11 selects the second autonomous vehicle V2 and the third autonomous vehicle V3 as the influencing vehicle AfV.

As a second method, the control unit 11 determines which other autonomous vehicle of the route to which the delayed vehicle DeV belongs is selected as the influenced vehicle AfV based on the magnitude of the delay calculated by S103. For example, when the delay calculated by S103 is more than 5 minutes and less than 10 minutes, the control unit 11 selects only one subsequent delay vehicle DeV as the influencing vehicle

AfV. When the delay calculated by S103 is more than 10 minutes, the control unit 11 selects all other autonomous vehicles of the route to which the delayed vehicle DeV belongs as the affected vehicle AfV. In the embodiment of FIG. 3, since the delay of the first autonomous vehicle V1 calculated by S103 is +10 minutes, the control unit 11 selects only the subsequent second autonomous vehicle V2 of the first autonomous vehicle V1 as the affected vehicle AfV.

As a third method, the control unit 11 determines which other autonomous vehicle of the route to which the delayed vehicle DeV belongs is selected as the influenced vehicle AfV by the magnitude of the difference between the operation interval and the desired interval. Specifically, the control unit 11 calculates an operation interval of the autonomous vehicle VE of the route to which the delayed vehicle DeV belongs from the operation result. The control unit 11 calculates a difference between the calculated operation interval and a desired interval. The control unit 11 selects an autonomous vehicle in which the calculated difference is larger than a desired distance as the influencing vehicle AfV. For example, the control unit 11 selects an autonomous vehicle whose operation interval is shifted from 20 minutes to more than 5 minutes, which is a desired interval, that is, whose operation interval is less than 15 minutes or more than 25 minutes, as the affected vehicle AfV. In the embodiment of FIG. 3, the control unit 11 calculates, at a time point of 10:10, an operation interval H12 between the first autonomous vehicle V1 and the second autonomous vehicle V2 as “a desired interval (20 minutes)+a delay of the second autonomous vehicle V2 (−10 minutes)−a delay of the first autonomous vehicle V1 (+10 minutes)=0 minutes”. The difference between the operation interval H12 and the desired interval is 20 minutes. The control unit 11 calculates the desired interval (20 minutes)+the delay of the third autonomous vehicle V3 (+0 minutes)−the delay of the second autonomous vehicle V2 (−10 minutes)=30 minutes as the operation interval H23 between the third autonomous vehicle V3 and the second autonomous vehicle V2. The difference between the operation interval H23 and the desired interval is 10 minutes. Therefore, the control unit 11 selects the second autonomous vehicle V2 and the third autonomous vehicle V3 as the influencing vehicle AfV.

In S105 of FIG. 6, the control unit 11 of the operation management device 10 calculates the standby period at the next-stop station, which instructs the influenced-vehicle AfV selected by S104, based on the operation result indicated by the result data acquired by S102. In the example of FIG. 3, when the first method is adopted, the control unit 11 calculates the standby time at the first stop S1 of the second autonomous vehicle V2 that is the selected influencing vehicle AfV and the standby time at the second stop S2 of the third autonomous vehicle V3. When the second method is adopted, the control unit 11 calculates a waiting period in the first stop S1 of the second autonomous vehicle V2 that is the influenced vehicle AfV. The third method is the same as the first method. As a method of calculating the standby time, any method can be adopted. For example, the control unit 11 calculates, as the standby time, a time for setting the operation interval in the operation result to be the same as the operation interval in the operation plan. In FIG. 3, when the first method is adopted, the control unit 11 calculates the standby time of the second autonomous vehicle V2 at the first stop S1 as 20 minutes. In this way, the control unit 11 sets the operation interval between the first autonomous vehicle V1 which is the delayed vehicle DeV and the second autonomous vehicle V2 which is the influenced vehicle AfV from 0 minutes to 20 minutes. The control unit 11 calculates the waiting time at the second stop S2 of the third autonomous vehicle V3 as 10 minutes so that the operation interval between the second autonomous vehicle V2, which is the influenced vehicle AfV, and the third autonomous vehicle V3, which is the influenced vehicle AfV, is from 30 minutes to 20 minutes. When the second method is adopted, the control unit 11 calculates 20 minutes only for the standby time at the first stop S1 of the second autonomous vehicle V2. The third method is the same as the first method.

In S106 of FIG. 6, the control unit 11 of the operation management device 10 outputs time data indicating the standby time calculated by S105. Specifically, the control unit 11 causes the communication unit 13 to transmit the time data. The communication unit 13 transmits the time data to the autonomous driving control device 20. The autonomous driving control device 20 receives the time data from the operation management device 10. The autonomous driving control device 20 transmits the received time-data to the affected vehicles AfV. The influencing vehicle AfV receives the time-data from the autonomous driving control device 20. The affected vehicles AfV waits at the next stop according to the waiting time indicated by the received time data. In FIG. 3, when the first method is adopted, the second autonomous vehicle V2, which is the affected vehicle AfV, waits for 20 minutes at the first stop S1, which is the next stop, from the time point of 10:10. The third autonomous vehicle V3, which is the affected vehicle AfV, waits for 10 minutes at the second stop S2, which is the next stop. When the second method is adopted, the second autonomous vehicle V2, which is the affected vehicle AfV, waits for 20 minutes at the first stop S1, which is the next stop. The third method is the same as the first method. As described above, the delay information of some of the autonomous vehicles is shared with other autonomous vehicles, so that the entire operation can be leveled. As a result, it is possible to level congestion such as the concentration of passengers in some of the autonomous vehicles.

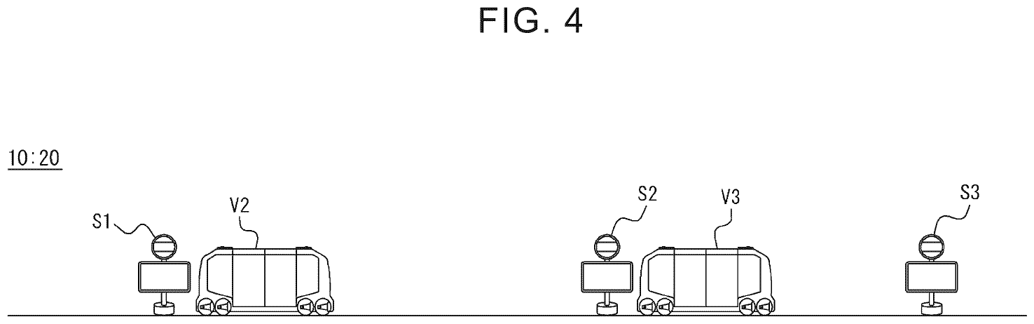

FIG. 4 is a diagram illustrating the operation status of the second autonomous vehicle V2 and the third autonomous vehicle V3 at 10:20 when the first process is adopted. At 10:20, the second autonomous vehicle V2, which is the affected vehicle AfV, is 10 minutes after starting the standby at the first stop S1. The departure time of the second autonomous vehicle V2 is 10:30 after waiting another 10 minutes. The third autonomous vehicle V3, which is the affected vehicle AfV, has arrived at the second stop S2. The departure time of the third autonomous vehicle V3 is 10:30 after waiting for 10 minutes.

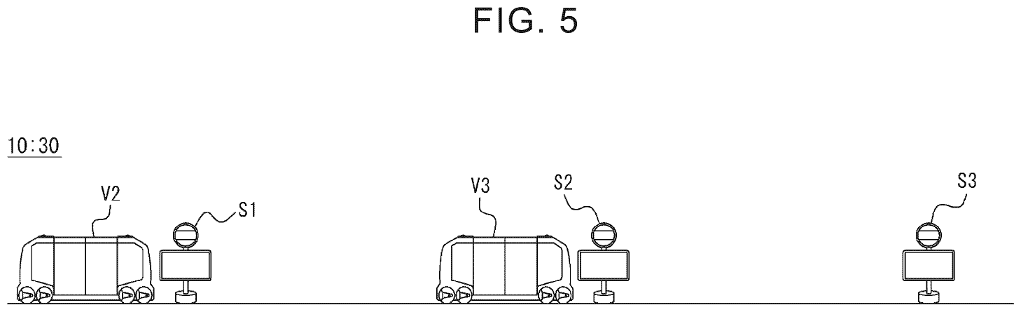

FIG. 5 is a diagram illustrating the operation status of the second autonomous vehicle V2 and the third autonomous vehicle V3 at 10:30 when the first process is adopted. At 10:30, the second autonomous vehicle V2, which is the affected vehicle AfV, has departed the first stop S1. The third autonomous vehicle V3, which is the affected vehicle AfV, has departed from the second stop S2.

After S106, the control unit 11 performs a S102 process. After S106, the control unit 11 may change the operation plan indicated by the operation plan acquired by S101 and then perform S102 process. That is, the control unit 11 may reflect the standby time calculated by S105 in the operation plan and detect DeV of delayed vehicles in S103 using the operation plan reflecting the standby time.

In S106, when outputting the temporal data, the control unit 11 may further output instruction data for instructing the influencing vehicle AfV to notify the passenger in the influencing vehicle AfV or the vehicle around the influencing vehicle AfV that the operation interval is being adjusted. Specifically, the control unit 11 may cause the communication unit 13 to transmit the instruction data. In such a modification, the communication unit 13 transmits the instruction data to the autonomous driving control device 20. The autonomous driving control device 20 receives the instruction data from the operation management device 10. The autonomous driving control device 20 transmits the received instruction data to the affected vehicle AfV. The influencing vehicle AfV receives the instruction data from the autonomous driving control device 20. The influencing vehicle AfV notifies the passenger in the influencing vehicle AfV or the vehicle around the influencing vehicle AfV that the operation interval is being adjusted according to the received instruction data. In the example of FIGS. 3 and 4, when the first method is adopted, the second autonomous vehicle V2, which is the affected vehicle AfV, starts waiting at the first stop S1, which is the next stop, at 10:10. The second autonomous vehicle V2 starts outputting a message to the signage inside and outside the vehicle, such as “Operation interval is being adjusted”, “Departure at 10:30” or “Waiting for 20 minutes”. The second autonomous vehicle V2 may be configured to output a similar message in the vehicle. The third autonomous vehicle V3, which is the affected vehicle AfV, does not output a notification at this point. At 10:20, the second autonomous vehicle V2 is outputting a message to the signage inside and outside the vehicle, such as “the operation interval is being adjusted”, “I will depart at 10:30”, or “I will wait for another 10 minutes”. When the third autonomous vehicle V3 starts waiting at the second stop S2, which is the next stop, it starts outputting a message to the signage inside and outside the vehicle, such as “the operation interval is being adjusted”, “the vehicle will depart at 10:30”, or “the vehicle will wait for another 10 minutes”. At 10:30, the second autonomous vehicle V2 and the third autonomous vehicle V3 terminate outputting the message. When the second approach is employed, only the second autonomous vehicle V2 issues a message. The third method is the same as the first method. By automating the notification in this manner, it is possible to reduce the burden on the crew member and provide accurate guidance as compared with a case where the crew member of the autonomous vehicle manually performs the notification. It is possible to automatically notify not only the inside of the vehicle but also the outside of the vehicle, and it is possible to share the fact that the operation interval is being adjusted to the passenger and the surrounding autonomous vehicle, thereby making the situation visible.

The autonomous driving control device 20 may be integrated with the operation management device 10. In this situation, the control unit 11 of the operation management device 10 may acquire the actual data by receiving the actual data from the autonomous vehicles 30 on a plurality of routes by the communication unit 13 in S102. The control unit 11 may transmit the time data and the instruction data to the affected-vehicle AfV by the communication unit 13 in S106, thereby outputting the time data and the instruction data.

In one embodiment, the process may be performed when providing a MaaS using the autonomous vehicles 30 on a plurality of routes. In this case, the information processing method according to the above-described processing procedure is an exemplary method of providing a service (MaaS) using the autonomous vehicles 30 on a plurality of routes.

As described above, in the present embodiment, the control unit 11 of the operation management device 10 acquires plan data indicating an operation plan for operating the autonomous vehicles 30 on a plurality of routes at regular intervals. The control unit 11 of the operation management device 10 acquires actual data indicating an operation result including a time at which the autonomous vehicle on each route arrives at each stop determined for each route. The control unit 11 of the operation management device 10 detects, as the delayed vehicle DeV, an autonomous vehicle whose delay from the time corresponding to the operation plan indicated by the acquired plan data at the time when the vehicle arrived at any one of the stopping places included in the operation result indicated by the acquired result data among the autonomous vehicles 30 on a plurality of routes exceeds a threshold value. Then, the control unit 11 selects, as the influenced vehicle AfV, an autonomous vehicle on one or more routes for adjusting the operation interval from among the autonomous vehicles 30 on a plurality of routes. The control unit 11 of the operation management device 10 calculates a waiting time at the next stop, which is instructed to the selected influencing-vehicle AfV, based on the operation result indicated by the result data. The control unit 11 of the operation management device 10 outputs time data indicating the calculated standby time.

According to the present embodiment, it is possible to adjust the operation interval of the autonomous vehicle in accordance with the delay state. Therefore, it is possible to improve measures against the delay of the autonomous vehicle.

In the present embodiment, the influenced vehicle AfV is selected from the route to which the delayed vehicle DeV belongs, but the influenced vehicle AfV may be selected from other routes to which the delayed vehicle DeV does not belong. When the autonomous vehicle of another route is also selected as the influencing vehicle AfV, it may be manually set which route is to be selected, that is, which route is to be considered as the transfer target. By cooperating with autonomous vehicles on other routes, it is possible to optimize the passenger transit time and the passenger waiting time.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

What is claimed is:

1. An operation management device comprising a control unit configured to:
acquire plan data indicating an operation plan for operating autonomous vehicles on a plurality of routes at regular intervals;
acquire record data indicating an operation record including times at which the autonomous vehicles on individual routes arrived at stops set on the individual routes;
when an autonomous vehicle in which delay of the time of arrival at any one of the stops in the operation record indicated by the acquired record data from a time associated with the operation plan indicated by the acquired plan data exceeds a threshold is detected as a delay vehicle among the autonomous vehicles on the routes, select, as an influence vehicle, an autonomous vehicle on one or more routes to be adjusted in terms of an operation interval from among the autonomous vehicles on the routes;
calculate a waiting period at a next stop for instruction to the selected influence vehicle based on the operation record indicated by the record data; and
output time data indicating the calculated waiting period.

2. The operation management device according to claim 1, wherein the control unit is configured to, when the delay vehicle is detected, select all other autonomous vehicles on a route to which the delay vehicle belongs as the influence vehicles.

3. The operation management device according to claim 1, wherein the control unit is configured to, when the delay vehicle is detected, determine, based on a magnitude of the delay, which other autonomous vehicle to select as the influence vehicle from among other autonomous vehicles on a route to which the delay vehicle belongs.

4. The operation management device according to claim 1, wherein the control unit is configured to, when the delay vehicle is detected, determine, based on a magnitude of a difference between the operation interval and a desired interval, which other autonomous vehicle to select as the influence vehicle from among other autonomous vehicles on a route to which the delay vehicle belongs.

5. The operation management device according to claim 1, wherein the control unit is configured to, when outputting the time data, further output instruction data for instructing the influence vehicle to notify an occupant in the influence vehicle or a vehicle around the influence vehicle that the operation interval is being adjusted.

6. A mobility-as-a-service providing method using the operation management device according to claim 1.
